(19) United States
(12) Patent Application Publication
(10) Pub. No.: US 2014/0340466 A1
(43) Pub. Date: Nov. 20, 2014

(54) SYSTEM AND METHOD FOR MULTI-EVENT VIDEO CONFERENCE SALES TRANSACTIONS

(71) Applicant: Kitsy Lane, Inc., Maynard, MA (US)

(72) Inventors: Andrew Fox, West Hyannisport, MA (US); Michael Tinglof, Concord, MA (US); Melissa Wilber, Gloucester, MA (US)

(73) Assignee: Kitsy Lane, Inc., Maynard, MA (US)

(21) Appl. No.: 13/894,791

(22) Filed: May 15, 2013

(51) Int. Cl. H04N 7/15

(52) U.S. Cl. CPC H04N 7/15
USPC 348/14.08

(57) ABSTRACT

A system and method for providing a multi-event videoconference correct marketing sales event is provided. Attendees walked into a videoconference event server's (VES) webpage, which then begins downloading a master event file of video clips to the way during the course of the event. The VES provides a step by step guide to managing the operation of the event including order entry and recruitment of future hosts.

### FIELD OF THE INVENTION

The present invention relates generally to online direct marketing systems.

### BRIEF DESCRIPTION OF THE DRAWINGS

The description of the present invention may be better understood by referring to the following description in conjunction with the accompanying drawings in which like reference numerals indicate identical or functional similar elements:

FIG. 1 is a schematic block diagram of an exemplary network environment in accordance with an illustrative embodiment of the present invention;

FIG. 2 is a schematic block diagram of an exemplary videoconference event server (VES) in accordance with an illustrative embodiment of the invention;

FIG. 3 is a schematic block diagram of an exemplary attendee computer in accordance with an illustrative embodiment the present invention;

FIG. 4 is a flowchart detailing the steps of a procedure for implementing a multi-event video conference direct market sales event in accordance with an illustrative embodiment of the present invention;

FIG. 5 is a exemplary graphical user interface (GUI) window illustrating a host's initial review in accordance with an illustrative embodiment of the present invention;

FIG. 6 is an exemplary graphical user interface (GUI) window illustrating a meet and greet step in accordance with an illustrative embodiment of the present invention;

FIG. 7 is an exemplary graphical user interface (GUI) window illustrating a location identification icebreaking activity in accordance with an illustrative embodiment of the present invention;

FIG. 8 is an exemplary graphical user interface (GUI) window illustrating a event plan in accordance with an illustrative embodiment of the present invention;

FIG. 9 is an exemplary graphical user interface (GUI) window illustrating data entry for an icebreaker activity in accordance with an illustrative embodiment of the present invention;

FIG. 10 is an exemplary graphical user interface (GUI) window illustrating participation in icebreaker activities in accordance with an illustrative embodiment of the present invention;

FIG. 11 is an exemplary graphical user interface (GUI) window illustrating completion of an icebreaker activity in accordance with an illustrative embodiment the present invention;

FIG. 12 is an exemplary graphical user interface (GUI) window illustrating style selection options in accordance with an illustrative embodiment of the present invention;

FIG. 13 is an exemplary graphical user interface (GUI) window illustrating style selection options in accordance with an illustrative embodiment of the present invention;

FIG. 14 is an exemplary graphical user interface (GUI) window illustrating a look book feature in accordance with an illustrative embodiment of the present invention;

FIG. 15 is an exemplary graphical user interface (GUI) window illustrating a look book feature in accordance with an illustrative embodiment of the present invention;

FIG. 16 is an exemplary graphical user interface (GUI) window illustrating ordering options in accordance with an illustrative embodiment of the present invention;

FIG. 17 is an exemplary graphical user interface (GUI) window illustrating billing and payment data entry in accordance with an illustrative embodiment of the present invention; and

FIG. 18 is an exemplary graphical user interface (GUI) window illustrating a next host sign up feature in accordance with an illustrative embodiment of the present invention.

### DETAILED DESCRIPTION OF AN ILLUSTRATIVE EMBODIMENT

The present invention provides an illustrative system and method for implementing videoconference based direct marketing sale parties that involve a plurality of attendees in a multi-person videoconference environment. In person direct marketing sale parties for the sale of goods are well-known. Typically, the host or hostess of the event will invite a plurality of friends to a particular location to demonstrate various products. The host will then take orders for the products for delivery at a later date. As will be appreciated, there are a number of disadvantages to a conventional in person sales event. One noted disadvantage is a limitation of geographic space from which friends may be invited. That is, friends of the host typically will not travel more than some short distance to attend an in person sales event. Thus, the universe of potential attendees to a sales event is limited. Another noted disadvantage of conventional in person sales parties is that the host of the event may be required to purchase a substantial amount of products to be able to display during the course of a event. This provides a potentially significant barrier to entry for potential hosts or hostesses.

The present invention illustratively utilizes dedicated hardware and/or software to implement a direct marketing sales event utilizing a multi-user videoconference. In operation, a videoconference event server (VES), described further below, provides a step-by-step guide for a host to facilitate attendees of the event to view products, engage in social interaction and/or place orders. Furthermore, the VES may also provide functionality for obtaining additional or new hosts to agree to host a event in the future. By expanding the number of hosts as time progresses, different circles of friends may be invited, thereby increasing the potential client base.

The host will invite a plurality of attendees to the direct market sales event and provide necessary login information to either a website that will host the event and/or information to download appropriate video conference software to be used on the attendee's computer. Attendees will log into the videoconference event server hosted webpage in accordance with an illustrative embodiment of the present invention. Similarly, the host will also log into the webpage. In response to an attendee and/or the host logging into the VES's webpage, the VES will begin downloading a master event file to each attendee's and host's computer. Illustratively, the master event file comprises the compilation of separate video clips that may be displayed during the course of the event. The master event file may further comprise information relating to specific merchandise including, e.g., pricing, image data, etc., games and/or other icebreaking activities and/or other applications to be executed. By downloading the master event file at login time, video may be played from an already downloaded file instead of being streamed during the course of the event. This may provide benefits of enabling all attendees to the event to view the video in a substantially simultaneous and synchronous manner. More specifically, by downloading the master event file, a video clip may be played and then paused until the next video clip is required to be played. This provides a built-in advantage over streaming video as those attendees with slower network connections will still be able to view the video in substantially real time with the other attendees. That is, the VES works to prevent those attendees with slower network connections from being out of sync with other attendees' viewing of a particular video clip due to network bandwidth issues.

Once all of the attendees have logged in, the VES provides a facilitated step-by-step guide to operating the direct marketing sales event to the host. Attendees may follow through using a graphical user interface and may also communicate with each other via a multi-event videoconference that occurs simultaneously with the directed steps of the event. The VES provides the functionality to allow late joiners to join the event once it has been initiated. Further, an attendee may be disconnected and rejoin the event. The VES provides functionality for a plurality of actions including, for example, icebreaking activities among the attendees of the event, features to identify styles that are considered fashionable by attendees, displaying of particular products to be highlighted, order entry, and functionality for volunteering to be the next host or hostess for a future event.

### Network Environment

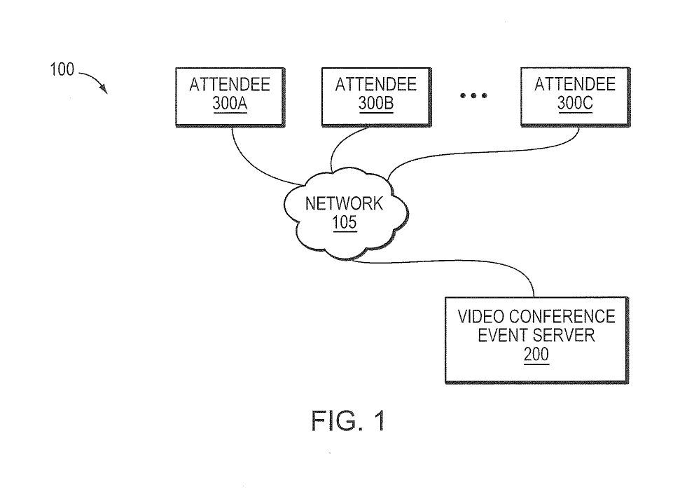

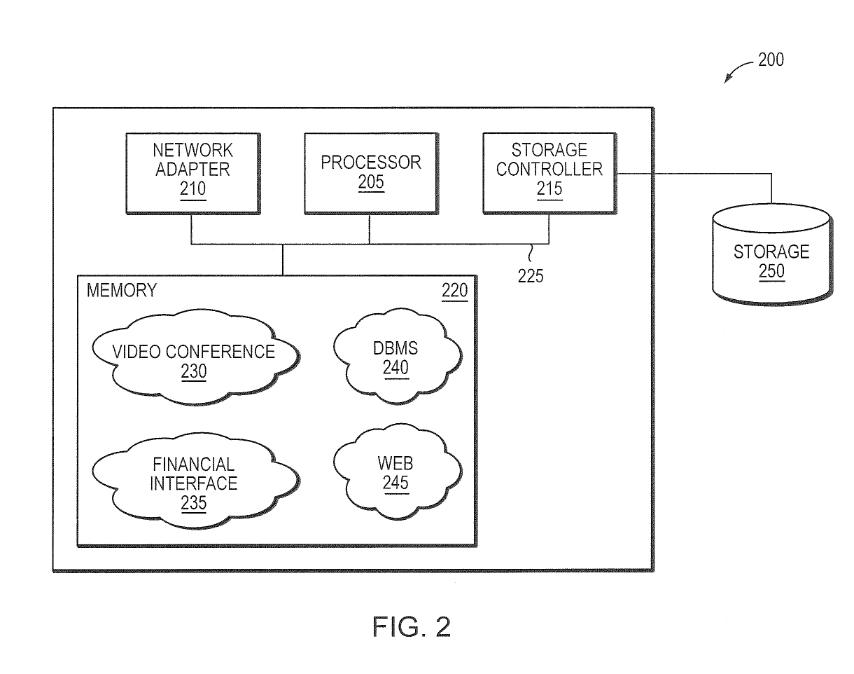

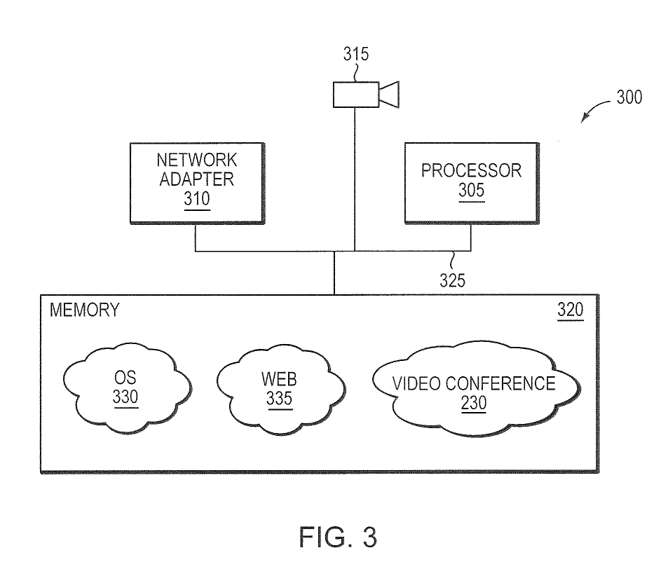

FIG. 1 is a schematic block diagram of an exemplary network environment 100 in which the principles of the present invention may be implemented in accordance with an illustrative embodiment of the present invention. The environment 100 is illustratively centered around a network 105 that may comprise any conventional form of networking including, for example, a TCP/IP network, a virtual private network (VPN), a local area network (LAN) or a wide area network (WAN), such as the well-known Internet. As will be appreciated by those skilled in the art, network 105 may comprise a plurality of different networks (not shown). It should be noted that the various networks may comprise different types and/or utilize differing protocols in accordance with alternative embodiments of the present invention. Portions of network 105 may comprise different types of networks, such as wireless networks, cellular networks, etc. in accordance with alternative embodiments of the present invention. As such, the description of network 105 comprising a single network should be taken as exemplary only. Operatively interconnected with the network 105 are a plurality of attendee computers 300A-C, described below in reference to FIG. 3, and a video conference event server (VES) 200, described further below in reference to FIG. 2.

### Videoconference Event Server (VES)

FIG. 2 is a schematic block diagram of an exemplary videoconference event server (VES) 200 in accordance with an illustrative embodiment the present invention. The VES 200 illustratively comprises a processor 205, network adapter 210, storage controller 215 and memory 220 interconnected by a network bus 225. The processor 205 typically comprises the necessary elements and/or logic adapted and configured to execute software programs and manipulate data structures in accordance with an illustrative embodiment of the present invention. While one processor 205 is shown and described in relation to FIG. 2, as will be appreciated by those skilled in the art, a plurality of processors 205 may be utilized to improve performance. Similarly, it should be noted that the description contained herein of the VES 200 comprising a single server should be taken as exemplary only. In accordance with alternative embodiments of the present invention, the functionality of the VES 200 may be distributed among a plurality of servers in a clustered configuration and/or may be distributed among a cloud-based server and/or storage environment.

The network adapter 210 illustratively contains the mechanical, electrical, and signaling circuitry for enabling communication of data over links coupled to the network 105. The network adapter 210 may be configured to transmit and/or receive data using a variety of different protocols including, inter alia, TCP/IP, UDP, ATM, asynchronous optical networks (SONET), wireless protocols, Frame Relay, Ethernet, fiber distributed data interface (FDDI), etc. Notably, the physical network adapter 210 may be used to implement one or more network interfaces, such as for a virtual private network (VPN) access, as will be known to those skilled in the art. It should be noted that in the illustrative embodiment described herein, a single network adapter 210 is shown and described operatively interconnecting the VES 200 to the network 105. However, it should be noted that in alternative embodiments, a plurality of network adapters 210 may be utilized to communicate with the network 105. Further, in alternative embodiments, a plurality of network adapters 210 may be utilized so that certain network adapters communicate with the network 105, other network adapters may directly communicate with parties' accounting systems 110, 120 and/or financial institution servers 130. As will be appreciated by those skilled in the art, a variety of network topologies may be utilized to implement the principles of the present invention. As such, the description of the network adapter 210 operatively interconnecting the VES 200 with network 105 should be taken as exemplary only.

The memory 220 stores a plurality of processes including, for example, a videoconference process 230, a financial interface process 235, a database management system process 240 and a web process 245. The videoconference process 230 illustratively provides the functionality to implement the multi-event videoconference direct marketing event in accordance with an illustrative embodiment of the present invention. In an exemplary embodiment, the videoconference process 230 may operate in conjunction with a third event videoconference server (not shown) to implement the multi-event videoconference as described herein. One exemplary third event that may be utilized is Google Hangouts available from Google, Inc. The financial interface process 235 operates in conjunction with the videoconference process 230 to handle payment processing for purchases made. As described further below, attendees to a videoconference event may make purchases. These purchases are illustratively processed by the financial interface process 235. This processing may include, e.g., credit and/or debit card processing, etc. The DBMS 240 illustratively manages a database (not shown) of products for sale, purchases, etc. More generally, the DBMS process 240 represents the back end accounting and inventory management system for the videoconference event sales. The web process 245 is illustratively implemented as a web server that operates in conjunction with the videoconference process 230 to provide a web site that is accessible by attendees to a direct market sales event.

The storage controller 215 manages access to storage 250 associated with the VES in accordance with an illustrative embodiment of the present invention. The storage 250 may comprise a plurality of disk drives arranged a fault-tolerant RAID array. However, it should be noted that in alternative embodiments, storage 250 may comprise any form of persistent media including, for example, flash RAM, tape, rewritable optical media, etc. Furthermore, the storage 250 may be distributed in a cloud-based environment with redundancy and/or fault tolerant features. For example, the storage devices may be arranged in RAID arrays to enable recovery from the failure of one or more of the storage devices. In an alternative embodiment, the storage 250 may be replicated and/or mirrored at one or more locations to enable near immediate access to data stored thereon in the event of the failure of one or more of the plexes of the minor.

### Attendee Computer

FIG. 3 is a schematic block diagram of an exemplary attendee computer 300 that may be utilized by one of the attendees to a videoconference event in accordance with an illustrative embodiment of the present invention. The computer 300 illustrative comprises a processor 305, a network adapter 310, an image capture device 315 and a memory 320 operatively interconnected by a bus 325. The processor 305 executes various processes stored in memory 320. The network adapter 310 operatively interconnects the attendees' computers 300 with network 105. As noted above in relation to FIG. 2, while a single network adapter 310 is shown and described, in alternative embodiments of the present invention, a plurality of network adapters may be utilized. As such, the description of a single network adapter 310 should be taken as exemplary only. The image capture device 315 illustratively comprises a web cam or other video capture device that is utilized by an attendee to provide a video of themselves during a multi-event videoconference event. Memory 320 illustratively comprises an operating system 330, a web browser 335 and a video conference software 320.

The operating system 330 illustratively comprises a conventional operating system that may be utilized by the attendees' computer 300. Exemplary operating system 330 may comprise Microsoft Windows, Mac OS, etc. The web browser 335 provides browser functionality to the attendee to log into a videoconference direct market sales event in accordance with an illustrative embodiment of the present invention. In accordance with an illustrative embodiment of the present invention, attendees access the videoconference direct market sales event by logging into a particular website using web browser 335. In accordance with an alternative embodiment of the present invention, dedicated videoconference software 230 may be utilized to access the video conference direct market sales event. As such, the description of a user logging into the direct market sales event via the World Wide Web should be taken as exemplary only.

### Videoconference Direct Market Sales Event

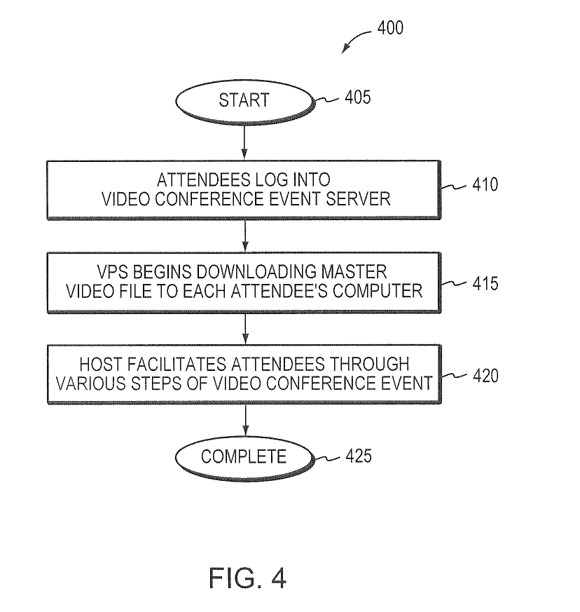

FIG. 4 is a flowchart detailing the steps of the procedure 400 for performing a multi-event video conference direct market sales event in accordance with an illustrative embodiment of the present invention. The procedure 400 begins in step 405 and continues to step 410 where the attendees log into the videoconference event server (VES) 200. Illustratively, attendees may log into the VES by accessing a website managed by the web process 240 of the VES 200. This is illustratively accomplished using a conventional username and password combination or, in alternative embodiments, may rely on other credentials, such as a Facebook account, Google+ account, etc. In an alternative embodiment of the present invention, attendees may utilize specialized video conference software executing on their computers to access the VES. In such an alternative embodiment, the videoconference software may provide the necessary credentials to log the attendee into the VES.

In response to attendees logging into the VES 200, the VES begins to download a master event file to each attendees' computer in step 415. Illustratively, a master event file is generated prior to the initiation of a videoconference direct market sales event. In accordance with an exemplary embodiment of the present invention, the master event file comprises a compilation of all video clips that may be played during the course of the videoconference direct market sales event. The master event file may also illustratively comprise game information, merchandise information such as images and/or metadata, map and location information, etc. As the various attendees log into the VES using network connections of different speeds, it is possible that the VES would be unable to stream, in real time, videos to all of the attendees. That is, an attendee utilizing a slower bandwidth network connection may not remain synchronized with attendees utilizing higher bandwidth connections. To avoid the possibility of attendees not remaining in sync during video playback, a master event file is downloaded in the background. In some cases, the master event file will have completed its download by the time the videoconference event begins. Then, during normal operation, each attendee's computer may play a portion of the master event file and then pause playback of the master event file. Thus, to the attendee, it appears as if video is being streamed; however, the entirety of the master event file had been downloaded and play back is simply being paused at the end of the particular component clips of the master event file. The VES may improve video performance and attendee experience by concatenating all video clips into a master event file that is downloaded in response to an attendee logging into the VES.

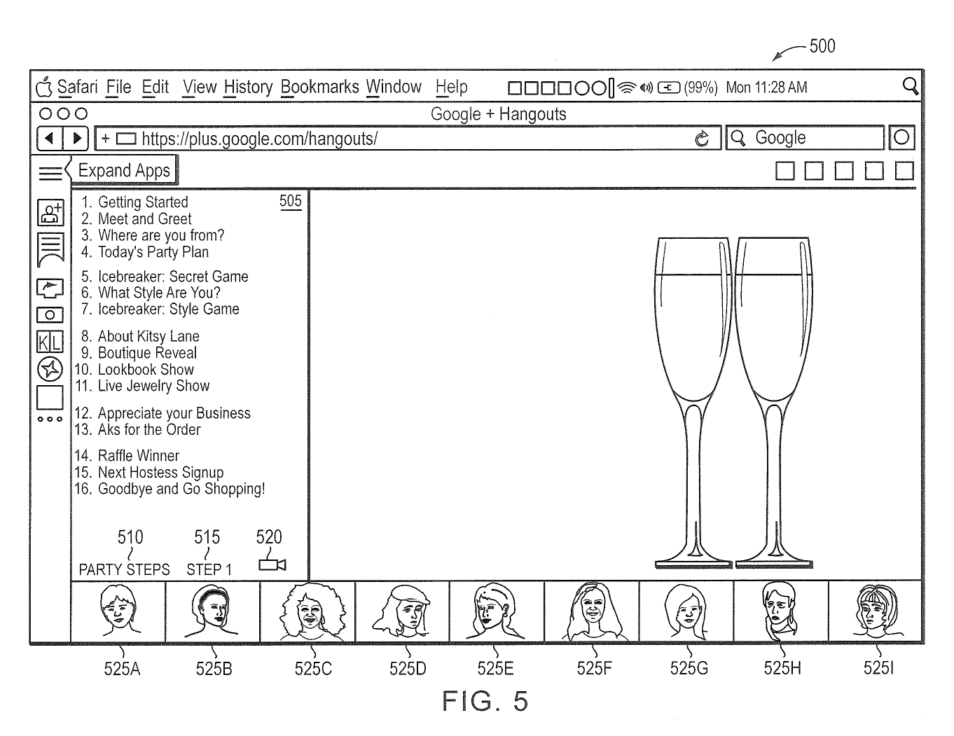

Illustratively, once all of the attendees have logged into the VES, the host of the videoconferencing event then facilitates the attendees through the various steps of the videoconference event in step 420. However, in alternative embodiments, attendees may log into the VES after the videoconference event has begun. Further, attendees may become disconnected from the videoconference event due to, e.g., loss of connectivity, network issues, etc. FIGS. 5-18 illustrate various exemplary graphical user interface (GUI) windows out of the various steps of the videoconference event in accordance with an illustrative embodiment of the present invention. The procedure 400 then completes in step 425.

FIG. 5 is an exemplary screenshot of a graphical user interface (GUI) window 500 illustrating a host's perspective of a videoconference event in accordance with an illustrative embodiment of the present invention. The window 500 illustratively comprises a plurality of different GUI features including, for example, a listing of event steps 505, a event steps tab 510, a next step button 515, a video button 520 and a plurality of videoconference images 525A-I. Illustratively, the event steps listing 505 comprises an ordered set of steps that is provided by the VES 200 to manage a videoconference event in accordance with an illustrative embodiment of the present invention. The exemplary window 500 also comprises a event steps button 510 within the window 580 that may be clicked by a host/attendee to display the list of event steps. In accordance with an illustrative embodiment of the present invention, the event steps button 510 is visible from all windows of the graphical user interface. Thus, the host may select the event steps button at any point in time to have the event steps listing 505 displayed and/or to enable the host or attendees to skip various steps of the structured event. A next button 515 illustratively enables the host to move to the next step within the event plan. Thus, as displayed in exemplary FIG. 5, the next step is step one of the event. The video button 520 enables the user to play particular videos which may be associated with steps of the event. It should be noted that in accordance with the illustrative embodiments of the present invention various videos may be associated with the steps of the event in addition to other forms of media including, for example, static graphics and/or text.

The videoconference images 525A-I represent miniature video images of the various attendees attending the videoconference event. In one illustrative embodiment of the present invention the videoconference images 525 are live video feeds from each of the attendees. In alternative embodiments, the videoconference images may comprise an avatar or other profile picture of attendees. This may occur when, for example, an attendee is lacking a working video camera but is still desirous of participating in the videoconference event.

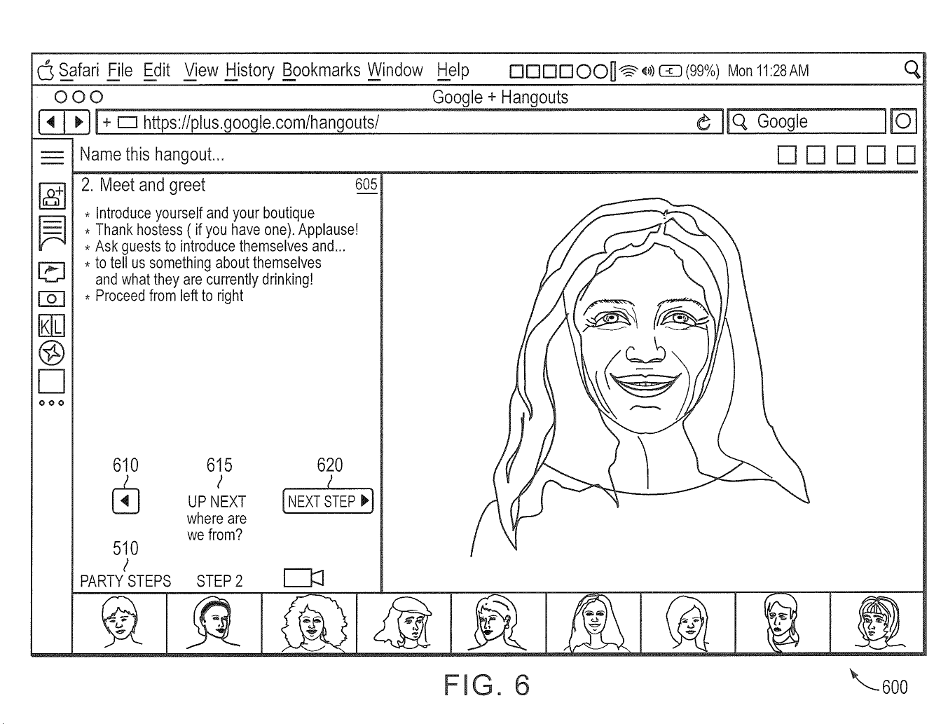

FIG. 6 is an exemplary screenshot of an exemplary graphical user interface (GUI) window 600 illustrating a meet and greet step of the event in accordance with an illustrative embodiment of the present invention. The window 600 illustratively comprises a meet and greet instruction set 605, a backward button 610, a preview of the next step field 615 and a next step button 620. Illustratively, the meet and greet instructions 605 outline talking points for the host of the videoconference event to help facilitate introductions among all the attendees of the event. Illustratively, the window 600 operates as a lavish person acted multi-parting videoconference. The various attendees are displayed in miniature in regions 525A-I, while the loudest is displayed in the primary videoconference area 625. That is, these smaller videoconference areas 525 display real-time images of the image acquisition devices of the various attendees, while the primary videoconference area 625 displays the live videoconference screen from which every attendee is the loudest. As will be appreciated by those skilled in the art, the techniques for determining which videoconference feed is prominently displayed may be utilized in accordance with alternative embodiments of the present invention. For example, an attendee may click on a videoconference feed 525A-I to manually select which feed should be displayed in the primary videoconference area 625. As such, the description of the loudest feed being prominently displayed should be taken as exemplary only.

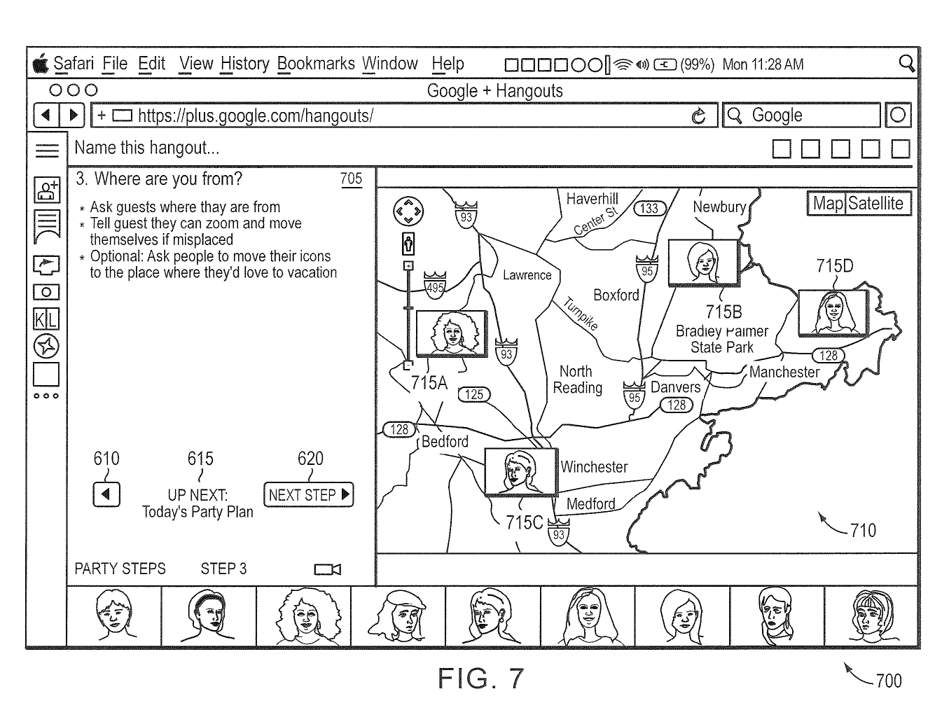

FIG. 7 is an exemplary graphical user interface (GUI) window 700 illustrating a location identification icebreaking activity in accordance with an illustrative embodiment of the present invention. In accordance with an illustrative embodiment of the present invention, the VES 200 may implement one or more icebreaking activities or games that may be played by the attendees. It should be noted that this description is of certain icebreaking activities; however, the principles of the present invention should be construed to cover any such icebreaking activities. As such, the description of a location identification activity should be taken as exemplary only.

Graphical user interface window 700 illustratively comprises a location identification icebreaking steps field 705, the back button 610, a preview field 615 in the next button 620. Further, exemplary graphical user interface window 700 comprises a field 710 that displays a map. The map may be zoomed in and out by attendees using conventional web-based tools. The VES provides functionality to enable each attendee to place an icon, such as a profile picture at a particular location on the map 710. These profile pictures 715A 2-D, enable attendees to visually show their location in relation to other attendees. In alternative embodiments, the attendees may be asked to place a picture on a location other than where they are currently located. For example, an attendee can be asked to place a picture of his or her favorite vacation spot, etc. As such, the description of attendees placing their indicator 715 in the location indicative of their current location should be taken as exemplary only. More generally, the VES provides the functionality to enable icebreaking activities, such as that described herein in relation to placing an indicator 715-7102 providing a sense of community among attendees to a videoconference event in accordance with alternative embodiments of the present invention. In one embodiment of the present invention, the functionality may be provided by a third-event, such as that provided by Google Maps feature. In alternative embodiments, the VES may provide the map functionality. In such embodiments where the map functionalities provided by a third-event, the VES will communicate with the third-event servers (not shown) to integrate the map functionality into the website displayed by the VES.

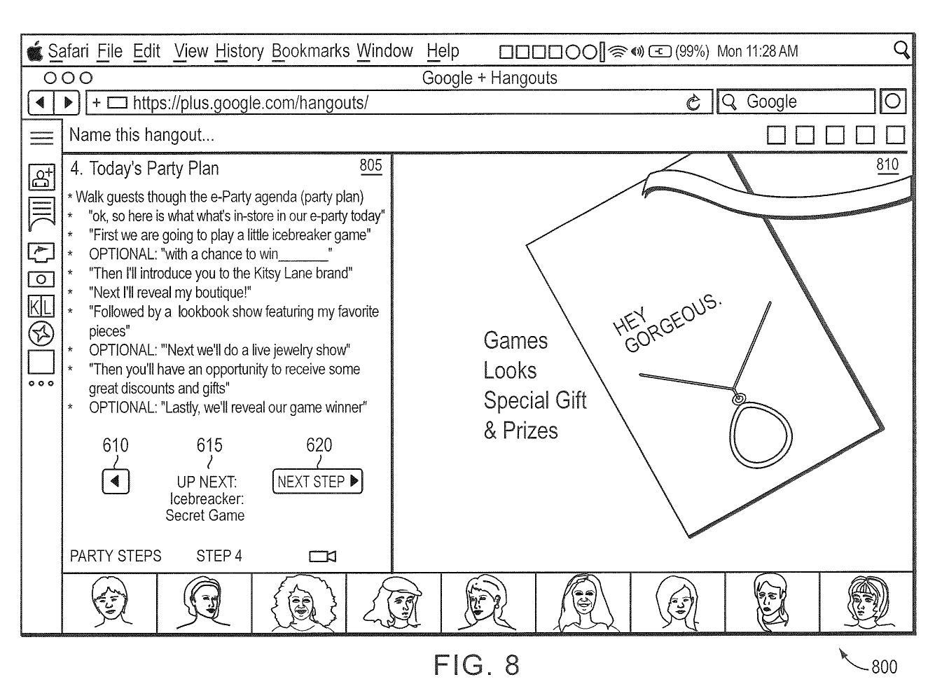

FIG. 8 is an exemplary graphical user interface (GUI) window 800 illustrating a event plan in accordance with an illustrative embodiment of the present invention. Exemplary window 800 comprises a guidance field 805 that outlines instructions for the host of the videoconference event to describe the operation of the videoconference event to the attendees. A display field 810 is utilized to display either a static image of the event with highlights or, in alternative embodiments, may display a video message preparing the attendees for the event. As noted above, the video to be displayed may comprise a portion of a master event file that was downloaded to each attendees' computer in response to them logging into the VES. In accordance with an illustrative embodiment of the present invention, the event plan video clip is played substantially simultaneously to all attendees. Once the video clip has been played to all attendees, each attendees' computer may then pause the master event file. Illustratively, the playback of the master event file may occur using conventional plug-ins to the web browser on each attendee's computer.

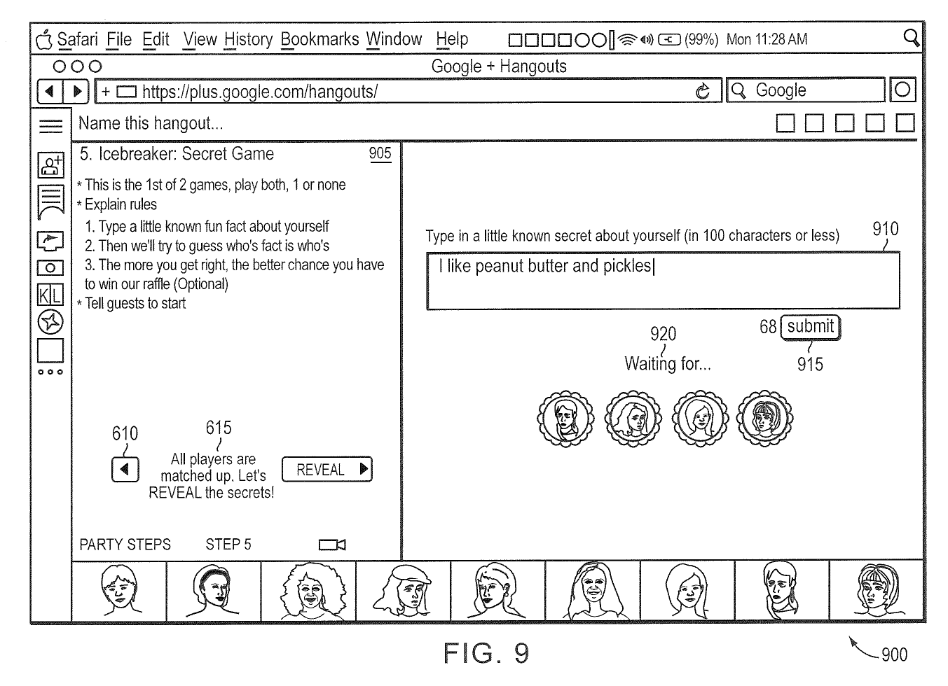

FIG. 9 is an exemplary graphical user interface (GUI) window 900 illustrating data entry for an icebreaker activity in accordance with an illustrative embodiment of the present invention. Field 905 contains guidance for operation of an icebreaker activity, namely a secret game. The main part of window 900 includes a field 910 that provides entry space for an attendee to enter a secret about themselves. A submit button 915 is provided to signify when an attendee has completed entry of his or her secret. Furthermore, the window 900 includes an indicator 920 illustrating those attendees who have yet to enter their secret.

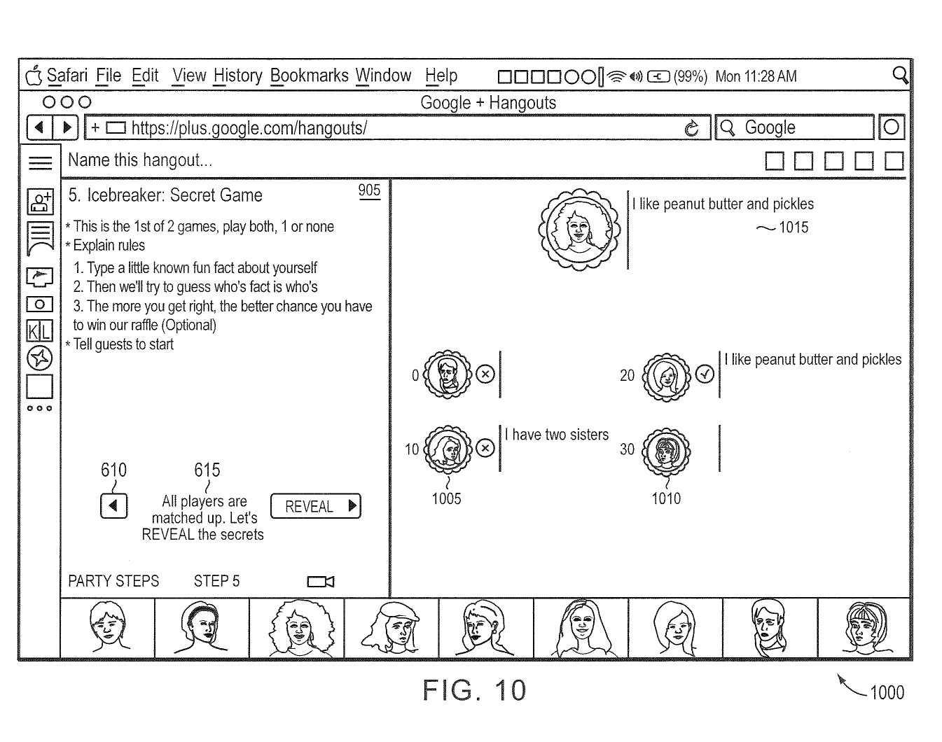

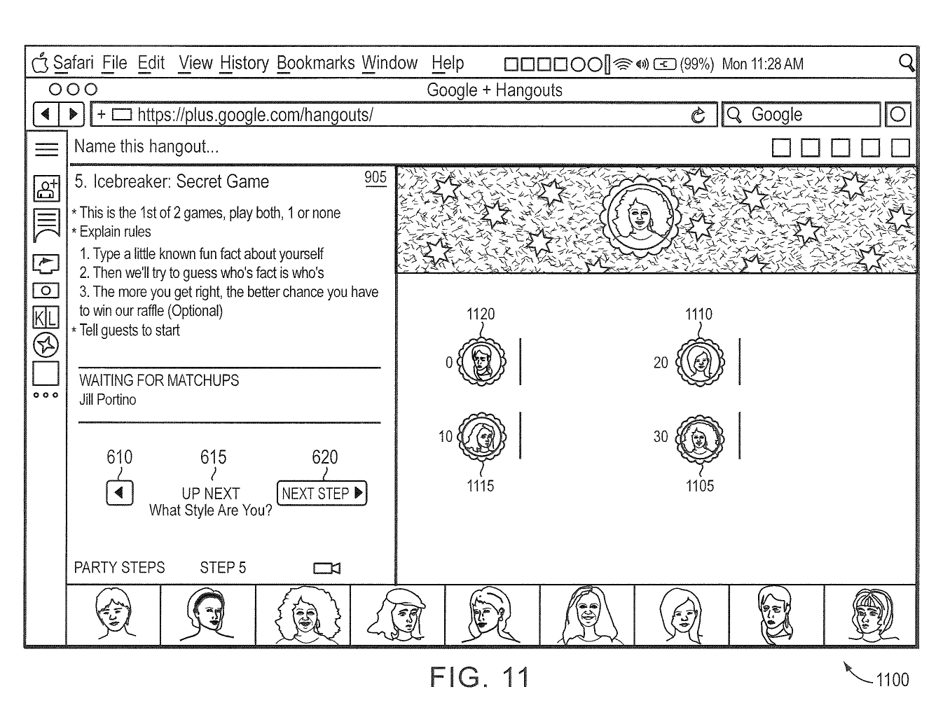

FIG. 10 is an exemplary graphical user interface (GUI) window 1000 illustrating participation in an icebreaker activity in accordance with an illustrative embodiment of the present invention. The main part of window 1000 provides space to enable attendees to attempt to match entered secrets with photos or images associated with the other attendees. FIG. 11 is an exemplary graphical user interface (GUI) window illustrating completion of an icebreaker activity in accordance with an illustrative embodiment the present invention. Window 1100 illustrates a scoring screen showing how many of the secrets were correctly guessed by the various attendees. To again summarize, FIGS. 9-11 illustrate exemplary graphical user interface windows detailing and exemplary icebreaking activity. As noted above in reference to FIG. 7, the VES 200 may implement one or more icebreaking activities that the attendees to the event may participate in. It should be noted that the exemplary is threatening activities described here in are shown for illustrative purposes only. Any interactive multi-event icebreaking activity that may be computer implemented may be utilized in alternative embodiments of the present invention. As such, the secret guessing game activity should be taken as exemplary only.

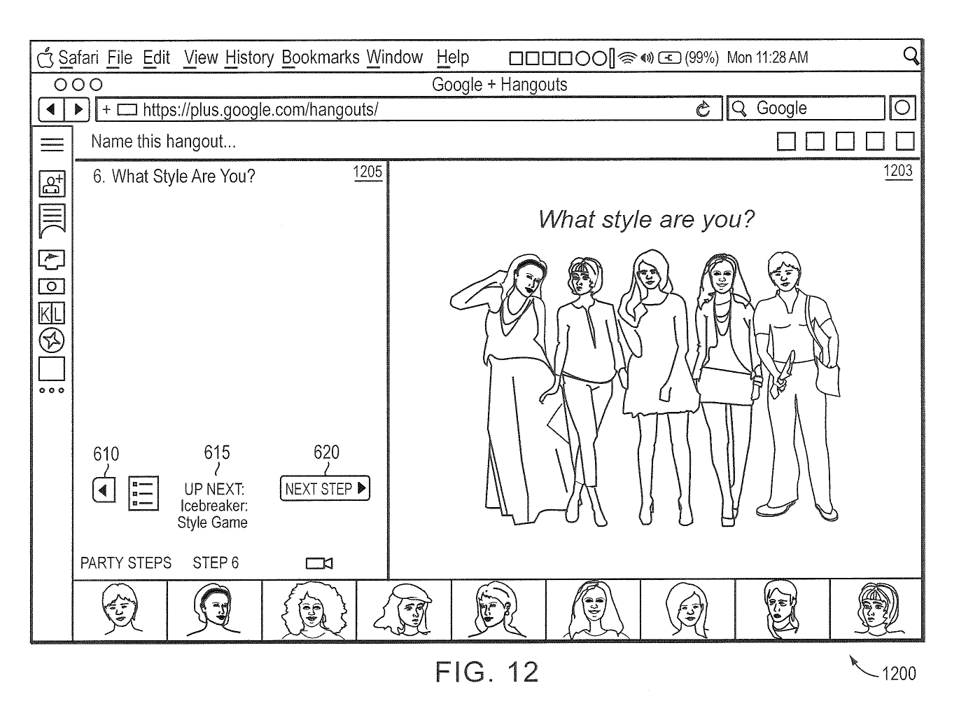

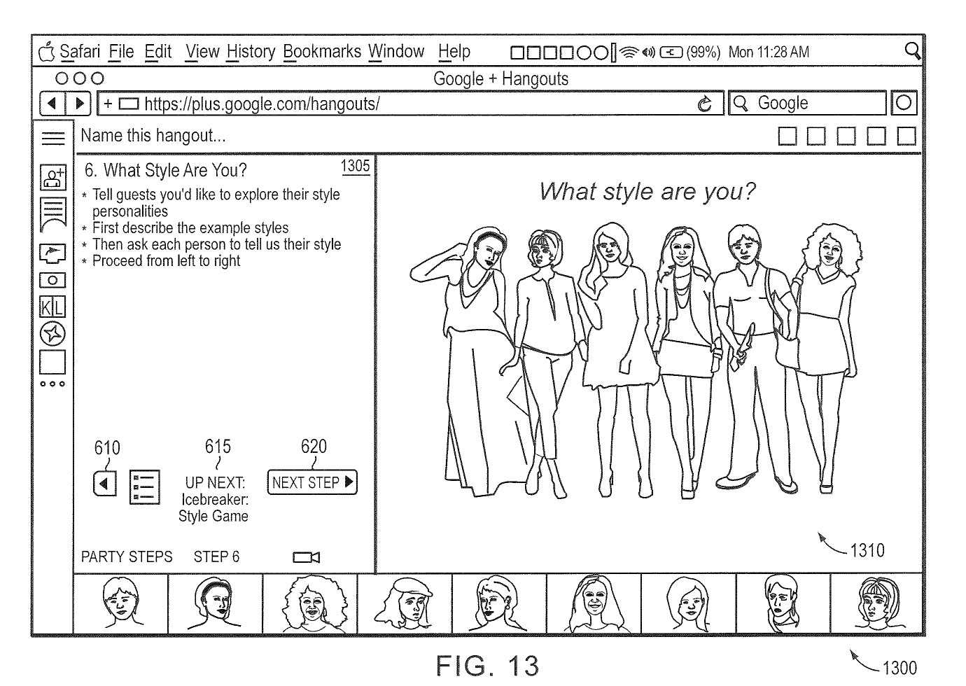

FIG. 12 is an exemplary graphical user interface (GUI) window illustrating a style selection options in accordance with an illustrative embodiment of the present invention. FIG. 13 is an exemplary graphical user interface (GUI) window illustrating a style selection option in accordance with an illustrative embodiment of the present invention. Illustratively, window 1300 includes a set of guidance information 1305 directed to the host of the event. Illustratively, the guidance information 1305 provides a set of instructions to be read to the attendees. Window 1300 also illustratively includes a style display region 1310 in which either an image and/or a video is display of various styles. Windows 1200 and 1300 may be utilized by the host of the event to identify styles that are desirable to the various attendees. This may enable certain products to be featured later in the event, for example, products associated with the style that the number of the attendees like maybe more prominently feature then products associated with a style in which none of the attendees expressed interest.

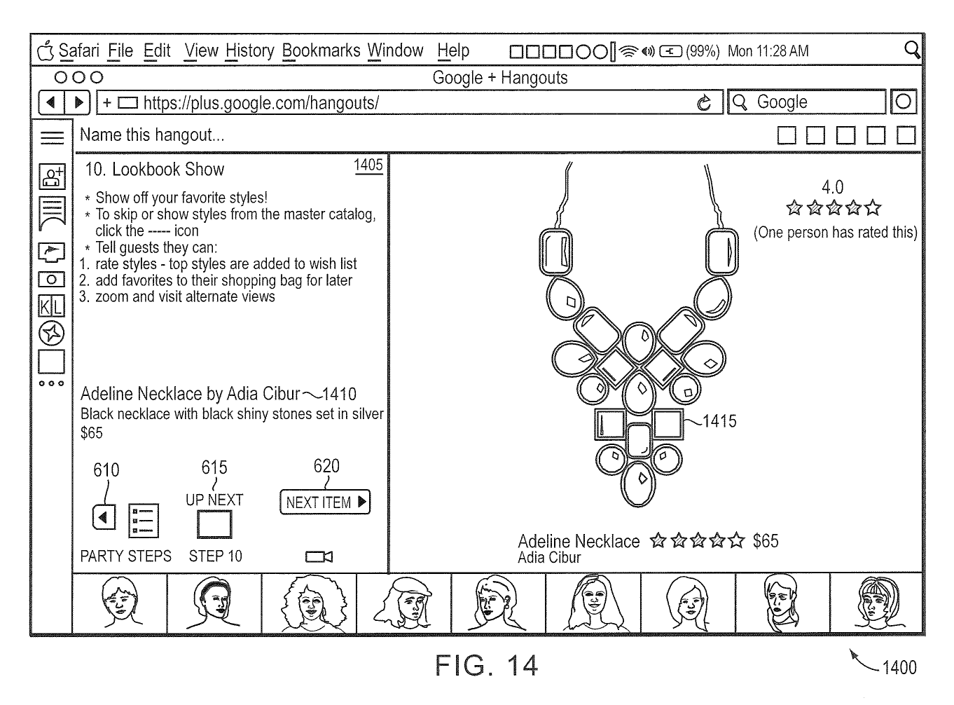

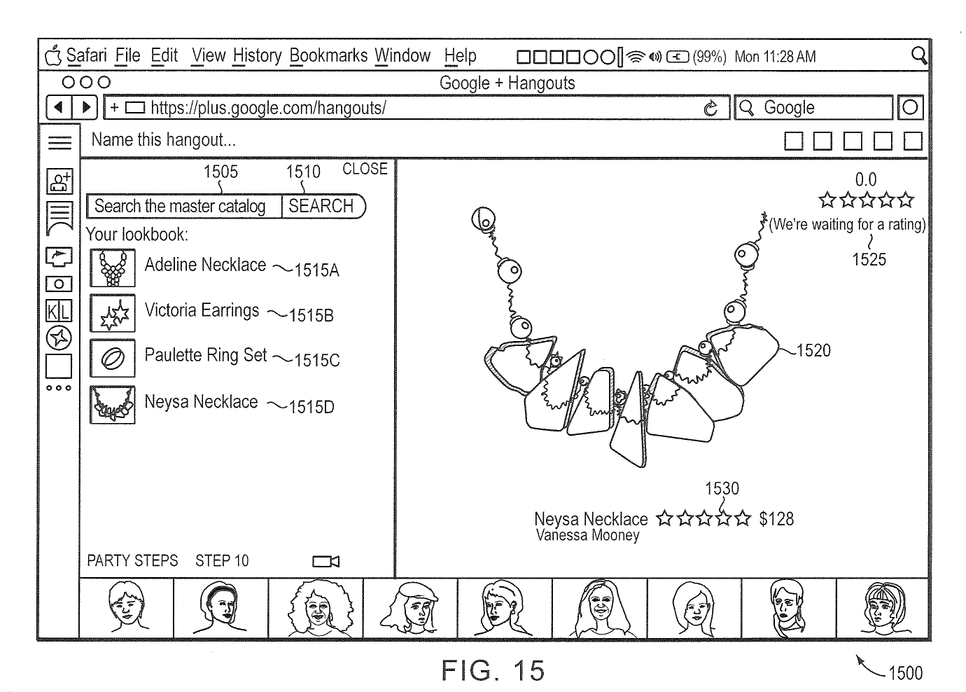

FIG. 14 is an exemplary graphical user interface (GUI) window 1400 illustrating a look book feature in accordance with an illustrative embodiment of the present invention. FIG. 15 is an exemplary graphical user interface (GUI) window illustrating a look book feature in accordance with an illustrative embodiment of the present invention. FIGS. 14 and 15 illustratively comprises graphical user interface (GUI) windows 1400 and 1500 that illustrate a look book feature of the VES 200 in accordance with an illustrative embodiment of the present invention. The look book feature enables the plurality of products to be displayed sequentially and permits attendees to rate a particular product. For example, in window 1500, there is the rating area 1525 where an attendee can indicate his or her rating of a particular product. Also in window 1500 is an overall rating field 1530 that indicates the average rating assigned to a product from the various attendees to the event. Window 1500 also provides functionality to enable an attendee to select alternative views of the product and/or to zoom in/out on the product.

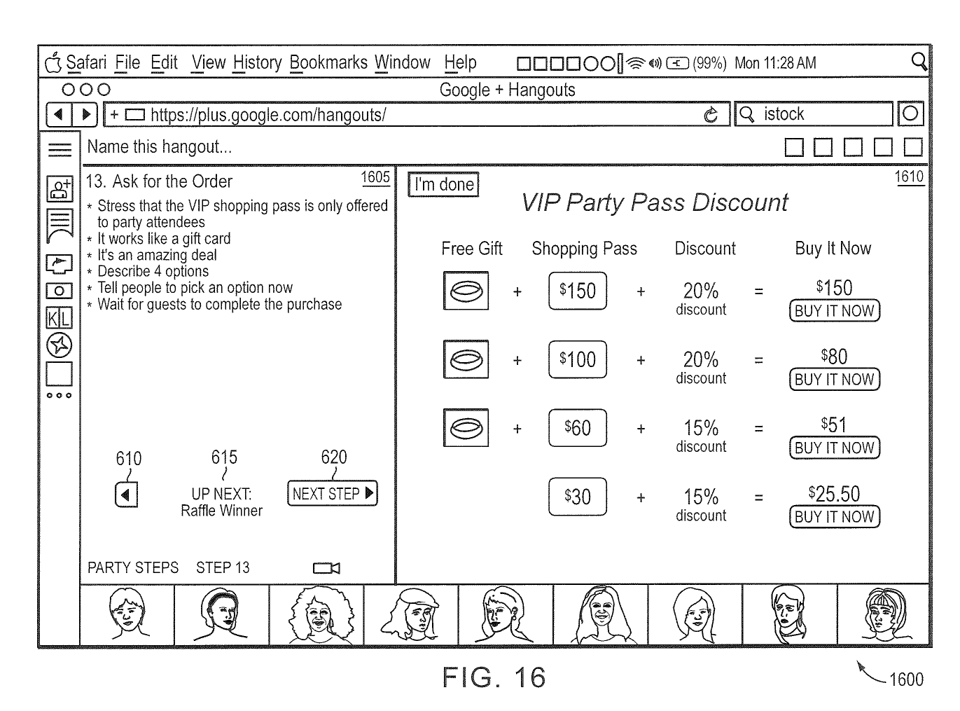

FIG. 16 is an exemplary graphical user interface (GUI) window 1600 illustrating ordering options in accordance with an illustrative embodiment of the present invention. Window 1600 illustratively comprises a display region 1610 that lists various ordering options to order a shopping pass. In accordance with an illustrative embodiment of the present invention, attendees purchase a shopping pass, i.e. gift card, that may be later used at the boutique associated with the event. This enables faster checkout during the event. However, in alternative embodiments, the VES 200 permits attendees to order individual products as part of the event.

In accordance with an illustrative embodiment of the present invention, attendees can work on entering order information while other attendees are viewing products, etc.

This permits an attendee to navigate away from the ordering window to, e.g., a look book window, etc. That is, order entry is illustratively an asynchronous process in relation to the videoconference event. In an alternative embodiment, the VES will provide completion information to the host to inform him or her of the status of ordering for each attendee. Further, the host may move an attendee between the ordering screen and any other window of the event. Thus, the host may help an attendee “catch up” to the rest of the attendees if one attendee has spent a lot of time on the ordering window, etc. Further, window 1600 also provides for the continued videoconference capabilities. Thus, if attendees are talking about ordering, all attendees will be able to hear that conversation to help drive additional orders.

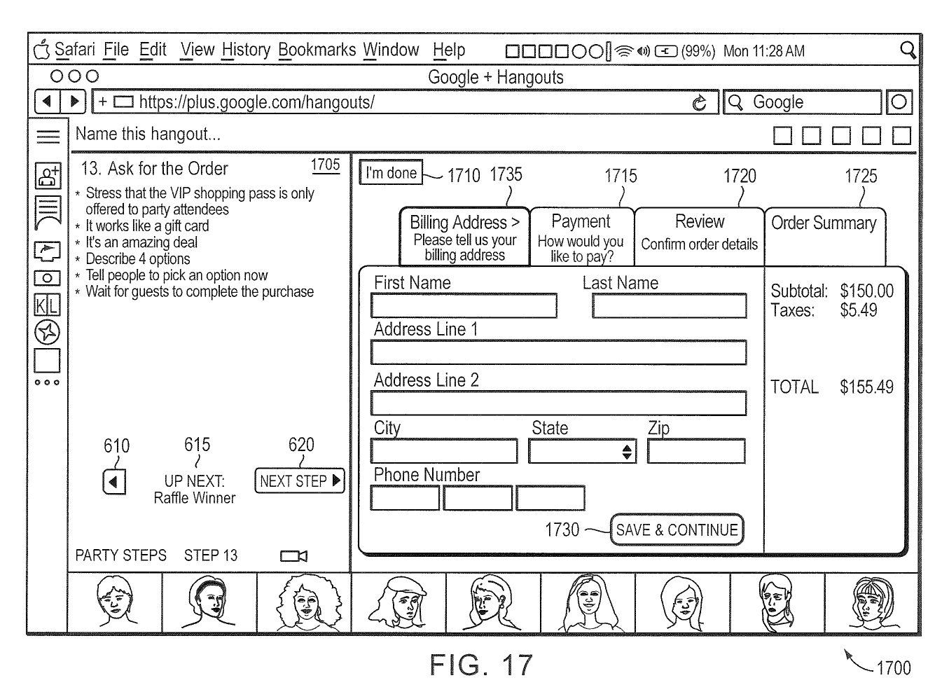

FIG. 17 is an exemplary graphical user interface (GUI) window illustrating billing and payment data entry in accordance with an illustrative embodiment of the present invention. Illustratively, window 1700 includes a instruction field 1705. Illustratively, window 1700 comprises an instruction field containing instructions for the host to solicit orders from the various attendees. The window 1700 also includes various tabs and fuels for data entry including, for example a billing address 1735, a payment tab 1715, and reviewed 1720 as well as the order summary 1725. A save and continue to 17 is provided that enables attendees to save information and continue to read next app. Furthermore, a completion button 1710 is provided to signify that an attendee has entered his or her ordering and payment information and is ready to complete the transaction. Once and attendee has entered his or her payment information, the VES, in conjunction with the financial process will process the entered payment information to effectuate payment. Further, the VES will interact with the DBMS process to have appropriate purchase orders generated for shipment of products that have been ordered. The back end fulfillment facility of the direct marketing sales company may then process the received orders in a conventional manner.

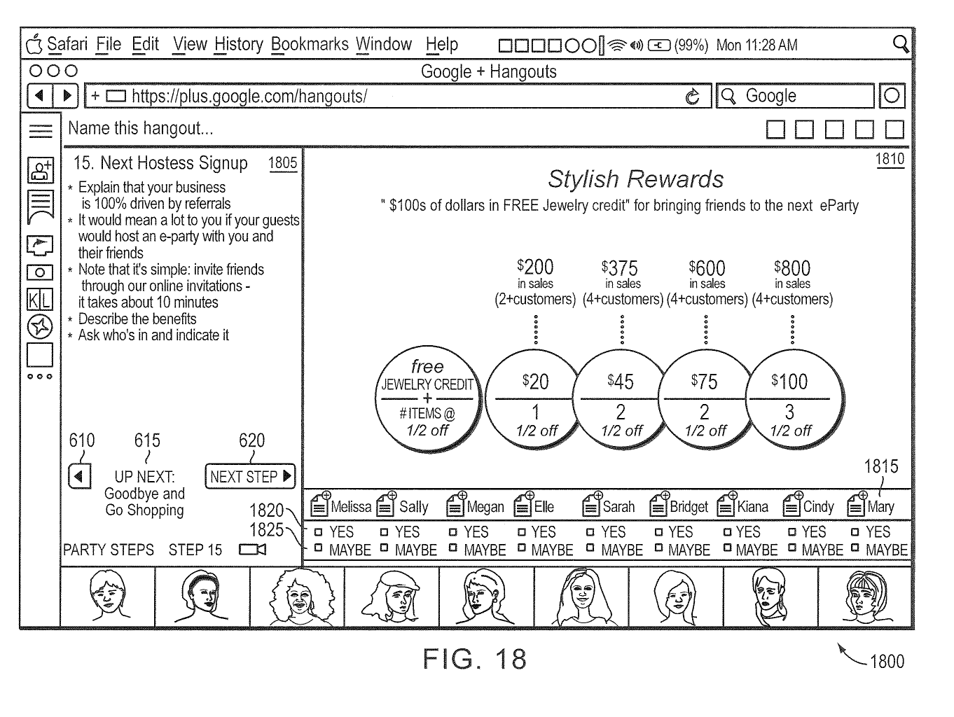

FIG. 18 is an exemplary graphical user interface (GUI) window 1800 illustrating in the next host sign up feature in accordance with an illustrative embodiment of the present invention. The window 1800 illustrative comprises a next hostess steps field 1805, a back button, a preview field 615 and a next button 620. Window 1800 also illustratively comprises a display 1810 of rewards associated with being a hostess of a event as well as a listing of each attendee and a yes click box 1820 and a maybe click box 1825 for each attendee. The steps field 1805 illustratively comprises guidance for a host of the event to use in facilitating this step with the event attendees. The rewards display 1810 comprises information relating to the compensation that is accorded to hostesses. It should be noted that while the display 1810 is shown graphically, in alternative embodiments, the display 1810 may comprise text, a spreadsheet, video, etc. As such, the description of a graphical representation of the display 1810 should be taken as exemplary only.

Various embodiments of the present invention have been shown and described herein. However, it should be noted that changes may be made to the various GUI windows in alternative embodiments without departing from the spirit or scope of the present invention. As such, the description of the layout, contents, features, etc. of the various GUI windows described herein should be taken as exemplary only. Further, the description of any particular GUI element as a button, box, menu, field, etc. should be taken as exemplary only. Additionally, the layout of any GUI window may be changed based on implementation specific details. As such, the layout and/or description of certain features being in a defined location within a GUI window should be taken as exemplary only. It should also be noted that the various processes of the present invention may be implemented in hardware, as software, including as a non-transitory computer readable medium, firmware and/or any combination thereof. As such, the description of a particular step being implemented as a computer software process should be taken as exemplary only.

What is claimed is:

1. A system comprising:
a plurality of attendee computers, each of the attendee computers executing a web browser configured to access a web page managed by a videoconference event server, each of the attendee computers further comprising a video acquisition device;
the videoconference event server configured to implement a structured event among each of the plurality of attendee computers.

2. The system of claim 1 wherein the videoconference event server comprises a processor executing a videoconference process, wherein the videoconference process is configured to download a master event file to each of the attendee computers.

3. The system of claim 2 wherein the master event file comprises a compilation of a plurality of video clips to be played during the structured direct market sales event.

4. The system of claim 2 wherein each attendee computer is configured to play a portion of the master event file and then pause the master event file so that the portion of the master event file is played substantially simultaneously by all attendee computers.

5. The system of claim 2 wherein the master event file comprises one or more icebreaker activities.

6. The system of claim 2 wherein the master event file comprises one or more location aware applications.

7. The system of claim 1 wherein the videoconference event server is further configured to provide one or more icebreaking activities as part of the structured direct market sales event.

8. The method of claim 1 wherein the structured event comprises a direct market sales event.

9. A method comprising:
providing a multi-party videoconference via a website, each of a plurality of attendees to the multi-party videoconference accessing the website using an attendee computer; and
enabling one or more of the plurality of attendees to utilize the website to effectuate a transaction during the multi-party videoconference.

10. The method of claim 9 wherein each of the one or more transactions are performed asynchronously.

11. The method of claim 9 wherein at least one of the one or more transactions comprises purchasing a gift card.

12. The method of claim 11 wherein at least one of the one or more purchases of a gift card comprises purchasing the gift card at a discount.

13. A method comprising:
providing a structured event to a plurality of attendees via a web page, wherein the structured event is moderated by a host;
wherein at least one of the attendees selects a first of a plurality of multimedia events that comprise the structured event; and
wherein at least one of the attendees selects a second of the plurality of multimedia events.

14. The method of claim 13 wherein the first multimedia event comprises an icebreaker game.

15. The method of claim 13 wherein the first multimedia event comprises a look book event.

16. The method of claim 13 wherein the first multimedia event comprises a video of one or more products.

17. The method of claim 13 wherein the second multimedia event comprises an icebreaker game.

18. The method of claim 13 wherein the second multimedia event comprises a look book event.

19. The method of claim 13 wherein the second multimedia event comprises a video of one or more products.

20. The method of claim 13 further comprising providing a host view that illustrates which, of the plurality of multimedia events, is being viewed by each of the plurality of attendees.
